(19) United States
(12) Patent Application Publication
(10) Pub. No.: US 2009/0283045 A1
(43) Pub. Date: Nov. 19, 2009

(54) Hay feeder for livestock

(76) Inventor: Richard M. Rutkowski, Upper Falls, MD (US)

Correspondence Address: Robert M. Gamson, Esquire;HODES, PESSIN & KATZ, P.A., Suite 400, 901 Dulaney Valley Road, Towson, MD, 21204, US

(21) Appl. No.: 12/152,234

(22) Filed: May 13, 2008

(51) Int. Cl. A01K 5/00; A01D 59/00

(52) U.S. Cl. 119/51.01; 53/399; 414/24.5

(57) ABSTRACT

A sheet of plastic formed into a tubular shape with a round bale of hay constrictively retained within the tube by a restraining means around the tube. The restraining means is tightened to hold the bale of hay. The hay within the plastic tube is used to feed livestock. A method of preparing the tube and a method of providing hay to livestock is disclosed.

### BACKGROUND OF THE INVENTION

1. Field of the Invention The present invention is directed to a device for holding hay for livestock to eat and more particularly to a device which reduces waste of the hay and protects the hay from the effects of weather. The invention is also directed to a method of retaining hay in a feeder and to a method for providing hay to feed livestock.

2. Description of Related Art

In recent years, hay for forage and feeding of livestock has been cut and rolled into circular bales (round bales). The round bales are formed in a variety of diameters and lengths. Some are very large and require special machinery to move the bales to a desired location. These round bales are frequently left in the field where the effects of weather result in the hay rotting, becoming mildew or wasted in other ways.

The usual way to feed the hay to livestock is to place the bales in a large circular crib which is formed with a plurality of spaced-apart arches around the perimeter of the crib. The livestock stand around the outside of the crib and extend their heads between the arches to reach the hay within the crib. Horses, in particular, take mouthfuls of hay, remove their heads from the pen and eat outside of the pen. Much of the hay falls on the ground outside of the pen. The horses also “toss” the hay resulting in further waste. The hay outside the crib becomes contaminated with body waste from the livestock. Also, the hay within the crib has no protection from the weather elements and may be within the crib for days. Mildew may form on the hay. Horses are particularly susceptible to illness from the mildew. The owner of the livestock must clean up frequently both inside and outside of the crib.

U.S. Pat. No. 4,712,676 to Roy et al disclose a reusable plastic cover to enclose and protect a bale of hay. However, this is for storage only and the cover must be removed to allow livestock to eat the hay.

Another device for protecting baled hay from moisture is disclosed in U.S. Pat. No. 4,248,343 to Schaefer.

U.S. Pat. No. 4,497,196 to Helton disclosed a molded unitary shell in which a round bale of hay is inserted. This protects the hay from the weather and also allows livestock to have access to the hay for feeding. However, this device is not adjustable for bales having different diameters. Bales which are smaller and do not fit in the shell, allow waste from wind or livestock. Larger bales cannot be placed in the shell. Also, larger bales require special equipment or machinery to load the bales of hay into the shell or to move the loaded shell to a feeding location.

### BRIEF SUMMARY OF THE INVENTION

It is an object of the present invention to provide a device which securely retains a circular bale of hay within a tubular form, shaped from a sheet of plastic material which has adjustable retaining means thereabout. The hay is thereby protected from the effects of weather. The hay within the tubular form is easily accessible by livestock and due to the configuration, there is a reduction in loss caused by tossing of the hay by the livestock and by contamination from livestock waste.

It is a further object of the present invention to provide a method of retaining a circular bale of hay for feeding livestock.

Another object of the present invention is to provide an improved method of feeding hay to livestock.

In accordance with the teachings of the present invention, there is disclosed a device for holding a bale of hay to feed livestock. A parallelepiped sheet of plastic has means attached to the sheet of plastic wherein the sheet may be formed into a tubular form and restrained in the tubular form. The circumference of the bale of hay is within and contacting, the tubular form so as to be available for the livestock to eat the hay from within the tubular form, the tubular form protecting the hay from elements of the weather, and from ground moisture, the tubular form reducing livestock tossing of the hay and reducing contamination from animal waste.

In further accordance with the teachings of the present invention, there is disclosed a method of retaining a bale of hay for livestock feed. A parallelepiped sheet of plastic material is provided. At least one strap is connected on a first side of the sheet. At least one retaining means is connected to a first end on the first side of the sheet of plastic material. A circular bale of hay is placed on its side on a second side of the sheet of plastic material. The circular bale of hay is placed on its side on a second side of the sheet of plastic material wherein the respective ends of the bale hay are perpendicular to the first end of the sheet of plastic material. The sheet of plastic material is rolled around the circular bale of hay and rolled toward the retaining means. The at least one strap is engaged with the at least one retaining means and the strap is tightened a desired amount around the plastic sheet thereby forming the plastic into a tubular shape around the bale of hay such that the circumference of the bale of hay contacts the second side of the plastic sheet and the bale of hay is constrained within the tubularly-shaped plastic sheet. In this manner, livestock feeding on the hay within the tubular shape have every access to the hay and do not push the bale of hay out of the tubularly-shaped plastic.

In still further accordance with the teachings of the present invention there is disclosed a method of providing hay to feed livestock. A tube is formed from a sheet of plastic material. The tube is retained with at least one strap and one retaining means. The strap is tightened around the tube. A circular bale of hay is securely retained within the plastic tube. The tube with the hay therein is manually placed in a location for livestock to have access to the hay within the tube. The hay is protected from the elements of the weather and contamination of the hay by livestock waste is reduced.

These and other objects of the present invention will become apparent from a reading of the following specification taken in conjunction with the enclosed drawings.

### BRIEF DESCRIPTION OF THE DRAWINGS

FIG. 1 is a perspective view of the prior art showing a horse eating hay from within a circular crib with the hay strewn about the outside of the crib.

FIG. 2 shows a circular bale of hay on its side in the back of a truck.

FIG. 3 is a perspective view of the first side of a sheet of plastic material showing the straps and the retaining means attached thereto.

FIG. 4 is a perspective view showing the bale of hay on its side in the second side of the sheet of plastic material.

FIG. 5 is a view of FIG. 4 showing the bale of hay between the ends of the sheet of plastic material.

FIG. 6 is a perspective view showing the sheet of plastic material around the bale of hay with one strap engaged to a retaining means.

FIG. 7 is a perspective view showing two straps engaged with respective retaining means and the straps pulled tightly to constrict the sheet of material around the bale of hay in a tubular form.

FIG. 8 is a perspective view showing a horse outside of the crib with the horse's head inside the tubular form of the plastic such that the horse may eat hay from within the tubular form of the plastic sheet.

FIG. 9 is a perspective view showing the tubular plastic form with a residual amount of hay therein after the livestock has eaten most of the hay.

### DETAILED DESCRIPTION OF THE INVENTION

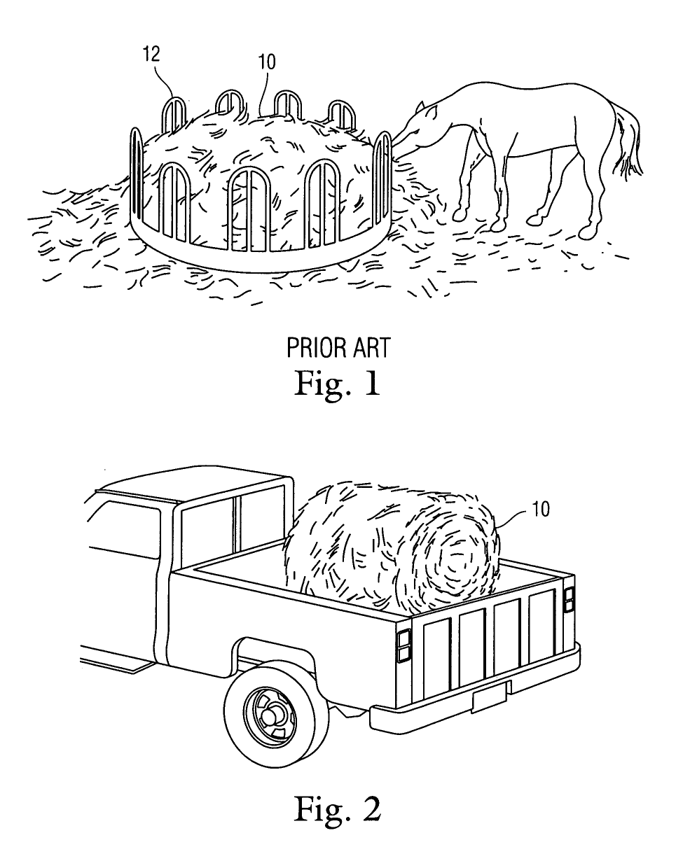

As seen in FIG. 1, the present procedure for feeding livestock is to place hay 10 within a round bale hay feeder crib 12 which is circular and has a plurality of spaced-apart arches formed thereon. The livestock stands outside of the crib and reaches its head between the arches to reach the hay. Note in FIG. 1 the typical waste of hay all around the outside of the pen.

FIG. 2 shows a typical round bale of hay 10 loaded in the back of a truck. The bale of hay as shown can be manually handled by one person.

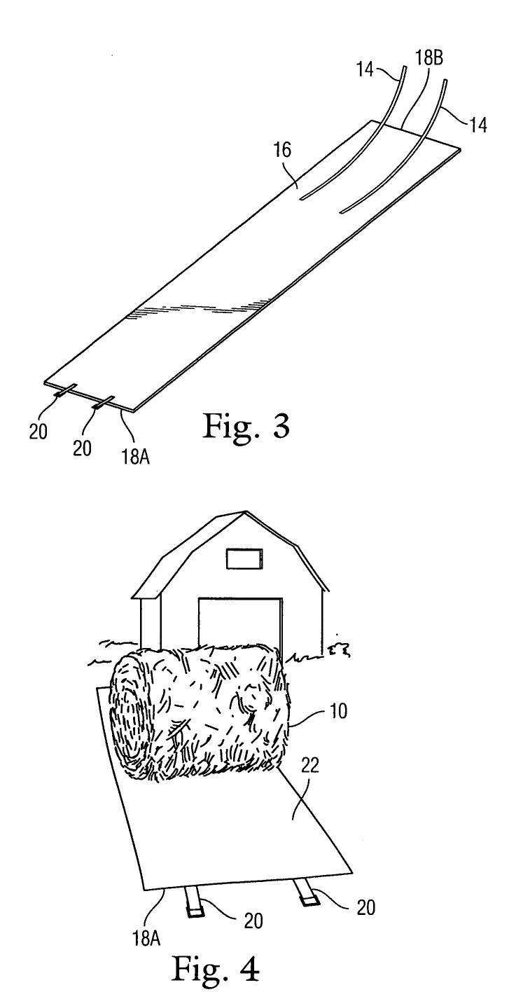

A sheet of flexible plastic material (FIG. 3) has at least one strap 14 securely attached to the first side 16 of the sheet. The attachment is between the ends (18A, 18B) of the sheet. Attached to one end 18A is at least one retaining means 20 which engages the strap 14 as will be explained. Although the preferred material is plastic, a metal or sturdy fabric may be used.

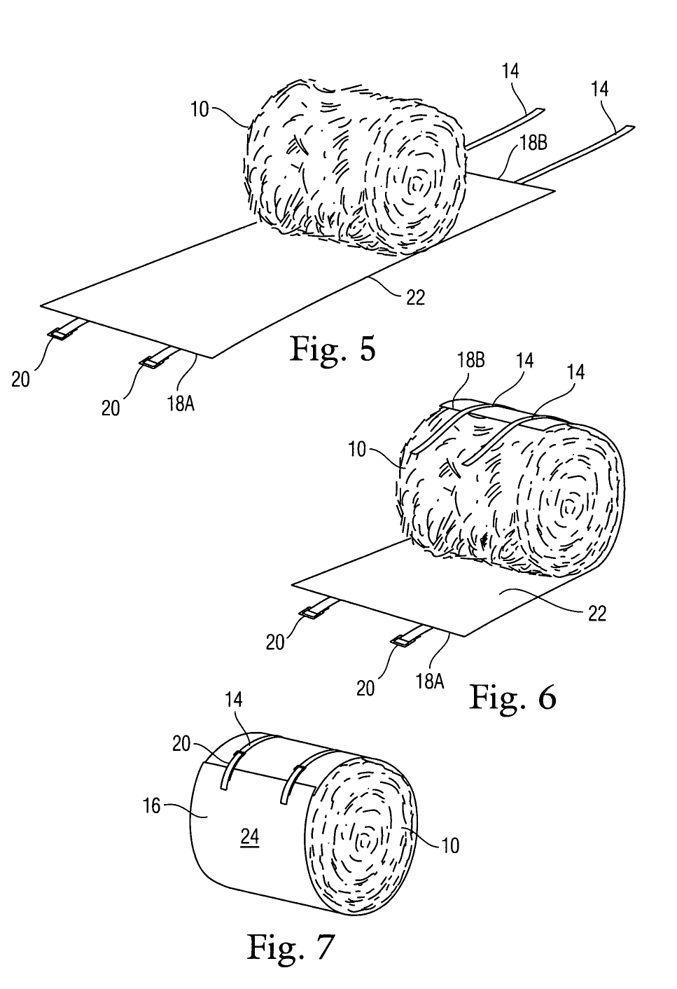

A round bale of hay 10 is placed on the second side 22 of the plastic sheet such that the side of the bale rests on the second side of the plastic sheet and the flat sides of the bale are perpendicular to the sheet of plastic. As seen in FIGS. 4 and 5. The bale of hay 10 is disposed between the ends 18A, 18B of the sheet of plastic and preferably further from the end on which the retaining means 20 is attached. The ends of the bale of hay are perpendicular to the ends of the plastic sheet.

The sheet of plastic is wrapped around the round bale of hay 10 to form a tube 24. This may be accomplished by rolling the sheet of plastic around the circular bale and rolling toward the retaining means on the sheet of plastic. Thus, the straps are brought closer to the retaining means and may be engaged with the retaining means. The strap 14 is pulled tightly to constrict the plastic sheet so that the inner (second) side of the plastic sheet is in contact with the bale of hay throughout the entire circumference of the bale of hay. The strap is engaged by the retaining means 20 to maintain the sheet of plastic in the constricted tubular form. Preferably there are at least two straps 14 and two retaining means (FIGS. 6 and 7). The retaining means may be any means to hold the strap known to persons skilled in the art including a buckle, a latch, a hook and loop fastener etc. It is preferred that a ratcheting means be used to provide for tightening the belt and constricting the plastic sheet into the tubular form. An elastic band or belt around the tube, not attached to the plastic sheet, may also be used.

The sheet of plastic may be of any desired size. However, for the most commonly used bale of hay, a parallelepiped sheet 4′ wide and 17′ long with a thickness of ⅛″-¼″ is preferred. The plastic sheet must have sufficient thickness to form and retain the tubular shape. The plastic preferably is a S.U.V. rated plastic which is resistant to light and weathering. Lexan® is a preferred material.

The bale of hay with the tubular plastic around the bale can be manually handled by one person.

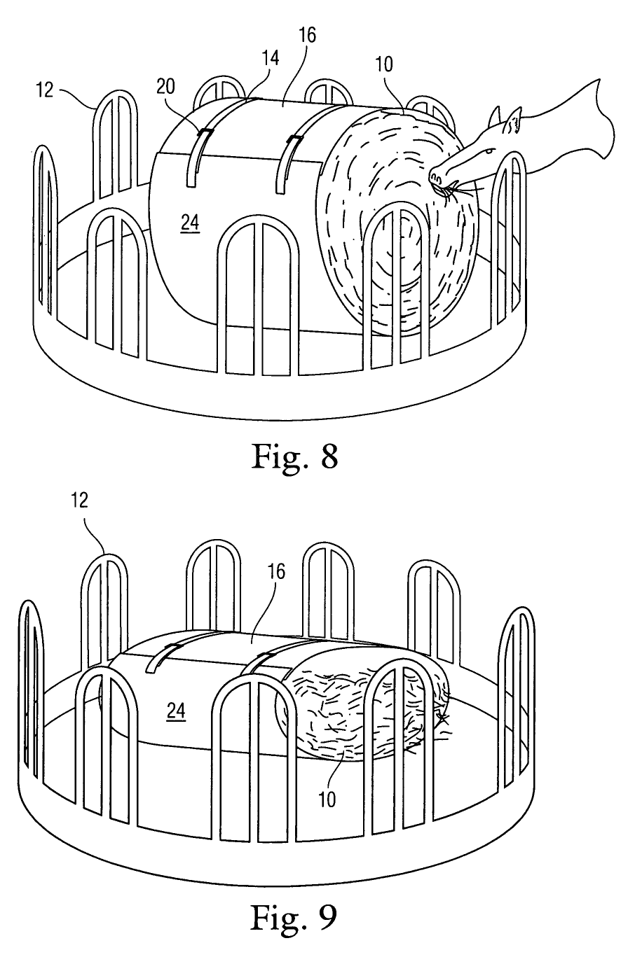

The tubular plastic with the hay enclosed may be placed in any desired indoors or outdoors location where the hay is available to livestock. A preferred location is in a crib 12 as shown in FIG. 8. The livestock can reach into the crib and eat the hay from the ends of the tube. The hay is contained and there is very little waste. As shown in FIG. 9, the livestock can eat all of the hay from within the tube. The livestock cannot step on or push the tube, bodily waste from the livestock cannot contaminate the hay and hay is not strewn outside of the crib. Thus, waste of hay is significantly reduced. Because the hay is confined within the tube, the affects of wind blowing the hay is not a significant problem.

Also, because the hay is constricted within the tube by the strap(s), it is not possible for the feeding livestock to push the hay out of the tubular shape as could occur with the prior art devices which are not constrained within the tubular plastic.

Frequently, when the hay is cut, a restraining material such as a binder or netting is placed on the bale to keep it in a circular form. This binder or netting is removed before the bale of hay is encircled with the plastic sheet. The hay is protected from elements of the weather and ground moisture. The tubular plastic containing the bale of hay may be stored out of doors for several months.

Obviously, many modifications may be made without departing from the basic spirit of the present invention. Accordingly, it will be appreciated by those skilled in the art that within the scope of the appended claims, the invention may be practiced other than has been specifically described herein.

What is claimed is:

1. A device for holding a circular bale of hay to feed livestock, comprising a flat parallelepiped sheet of a flexible material having means attached to the sheet of material wherein the sheet may be rolled and formed into a tubular shape and retained in the tubular shape around the circular bale of hay, the circumference of the bale of hay contacting the sheet of material in its tubular shape wherein the hay is protected from weather and from ground moisture and wherein livestock may eat the hay from within the tubular shape.

2. The device of claim 1, wherein the sheet of flexible material is a S.U.V. rated plastic material which is resistant to deterioration from exposure to weather conditions.

3. The device of claim 1, wherein at least one strap is attached to the sheet of flexible material, at least one retaining means is attached to a first end of the sheet of flexible material, the at least one strap being engaged by the at least one retaining means and the at least one strap being tightened around the tubular shape to retain the bale of hay.

4. The device of claim 3, wherein the at least one retaining means is a ratcheting device which engages the at least one strap and which may be tightened to a desired degree.

5. A method for retaining a circular bale of hay for feeding livestock comprising the steps of:
providing a parallelepiped sheet of flexible plastic material,
connecting at least one strap to a first side of the sheet of plastic material,
connecting at least one retaining means to a first end of the first side of the sheet of plastic,
placing the circular bale of hay on its side on a second side of the sheet of plastic material wherein the respective ends of the bale hay are perpendicular to the first end of the sheet of plastic material,
rolling the sheet of plastic material around the circular bale of hay and rolling toward the retaining means,
engaging the at least one strap with the at least one retaining means and tightening the strap a desired amount around the plastic sheet thereby forming the plastic into a tubular shape around the bale of hay such that the circumference of the bale of hay contacts the second side of the plastic sheet and the bale of hay is constrained within the tubularly-shaped plastic sheet, such that livestock feeding on the hay within the tubular shape have every access to the hay and do not push the bale of hay out of the tubularly-shaped plastic.

6. The method of claim 5, wherein the sheet of plastic material is a S.U.V. rated plastic material which is resistant to deterioration from light.

7. The method of claim 5, wherein the at least one retaining means is a ratcheting device.

8. The method of claim 5, wherein the steps are conducted manually.

9. The method of claim 5, wherein restraining material for the circular bale of hay is removed after the circular bale of hay is placed in the second side of the plastic sheet of material.

10. A method of providing hay to feed livestock comprising the steps of:
forming a tube from a sheet of plastic material and retaining the tube with at least one strap and at least one retaining means tightening the strap around the tube, wherein a circular bale of hay is securely contained within the plastic tube,
manually placing the tube with the hay therein in a location for livestock to have access to the hay within the tube,
wherein the hay is protected from the elements of the weather, and contaminates of hay by livestock waste is reduced.

11. The method of claim 1, wherein the plastic tube with the hay therein is disposed in a pen such that the head of the livestock can reach within the pen but bodily contact of the livestock with the plastic tube is limited.
